(19) United States
(12) Patent Application Publication
(10) Pub. No.: US 2021/0049681 A1
(43) Pub. Date: Feb. 18, 2021

(54) Business Mode and Apparatus for a Mobile Bank

(71) Applicant: Xuezhi Zhang, Guangzhou (CN)

(72) Inventor: Xuezhi Zhang, Guangzhou (CN)

(21) Appl. No.: 16/660,821

(22) Filed: Oct. 23, 2019

(30) Foreign Application Priority Data
Aug. 14, 2019 (CN) 201910752815.8

(51) Int. Cl. G06Q 40/02; G06Q 20/10; G06Q 20/04; G06Q 20/32; G06Q 20/40; G07F 19/00

(52) U.S. Cl. CPC G06Q 40/02; G06Q 20/108; G06Q 20/105; G07F 19/211; G06Q 20/3223; G06Q 20/40; G06Q 20/04

(57) ABSTRACT

A mobile bank is involved with the information system of financial industry.

The present invention put forth a mobile bank, which is comprised of a bank server running the bank information system and a properly designed vehicle equipped with one or several banking equipments which can communicate with the bank server to process banking transactions and provide banking service through 5G or other wireless communication technology; the mobile bank provides a substitute or transition to entity banks during the banking virtualization process on the internet, saving operation cost for banks by reducing rental expenses and human resources expenses.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is related to the information system for a mobile bank.

With the rapid development of communication and financial technology, banking become more and more virtual via the internet. Entity bank and ATMs are becoming more and more unnecessary; and the running cost becomes more and more expensive owing to the high cost of rental expenses and human resources. During the process of banking virtualization on the internet, mobile banks based on 5G or other wireless communication technology are good choices as substitutes or transitions.

### BRIEF SUMMARY OF THE INVENTION

The present invention is to build a mobile bank by equipping a properly designed vehicle that can move around with banking equipments based on 5G or other wireless communication technology such as ABM (Automatic Banking Machine), ATM (Automatic Teller Machine), ACBM (Automatic Company Banking Machine), IMM (Investment Management Machine), UBPM (Utility Bill Payment Machine), AFEM (Automatic Foreign Exchange Machine), computers, client machines and Pads etc. The banking equipments on the vehicle can communicate with the banking server which runs the bank information system to process various banking transactions and provide banking services through 5G or other wireless communication technology.

The vehicle for the mobile bank can be an unmanned robotic vehicle, an automatic driving vehicle, a normal vehicle with a driver or it can be a manned automatic driving vehicle. Banking staff, especially company banking staff, can be assigned on duty on board the vehicle; or no banking staff is assigned on duty on the vehicle; or bank service robots can be equipped on the vehicle to provide services.

### DETAILED DESCRIPTION OF THE INVENTION

The present invention put forwards the business mode and apparatus for a mobile bank. The mobile bank is built by equipping a properly designed vehicle that can move around with banking equipments based on 5G or other wireless communication technology such as ABM (Automatic Banking Machine), ATM (Automatic Teller Machine), ACBM (Automatic Company Banking Machine), IMM (Investment Management Machine), UBPM (Utility Bill Payment Machine), AFEM (Automatic Foreign Exchange Machine), computers, client machines and Pads etc. The banking equipments on the vehicle can communicate with the remote bank server which runs the bank information and management system processing various banking transactions and providing banking services through 5G or other wireless communication technology.

The mobile bank can cruise along fixed routes to provide services at fixed places at fixed times; it can also go to an appointed place at an appointed time for service according to a customer's appointment; it can also drive to places where people gather for events to provide service; it can also drive around and stop for service at customers' requests; it can also provide service to customers on the vehicle while driving; it can of course provide a combination of the above services.

There can be several mobile banks servicing at different routes at the same time; there can also be several mobile banks going to different appointed places to provide services for different customers.

The apparatus for the mobile bank in the present invention includes a properly designed vehicle equipped with banking equipments based on 5G and other wireless communication technology such as ABM, ATM, ACBM, IMM, UBPM, AFEM, computers, client machines and Pads etc. and a bank server that runs the banking information and management system, the driving system of the mobile bank and the banking equipments on board can communicate with the bank server through 5G or other wireless communication technology to control the vehicle and to provide banking services. The bank server can be a cloud computing server; it can also be a normal server.

The door of the mobile bank can be opened automatically when stopped for service; it can also be opened by bank cards, or by random password assigned when making appointments, or by face recognition of customers.

The start up and stop for service of the mobile bank can be controlled by the driver or bank staff on duty; they can also be controlled remotely by the control center of the bank information and management system. The start up and stop for service of the mobile bank with an unmanned robotic vehicle is controlled remotely by the control center of the bank information and management system or by control staff.

In one embodiment of the present invention, the bank server also runs AI (artificial intelligence) investment advisor, AI loan advisor, stock and fund transaction system and insurance service system. In correspondence, the mobile bank is equipped with AI investment advisor clients or Apps, AI loan advisor clients or Apps, stock and fund transaction clients or Apps and insurance service clients or Apps.

The above technical schemes include the preferred technical scheme of the present invention, but the present invention also covers various variants of the above technical schemes according to the innovative thoughts, ideas or concepts of the present invention, e.g. the mobile bank can be staffed with investment advisors or equipped with AI investment advisor clients or Apps, it can also be staffed with loan advisors or equipped with AI loan advisor clients or Apps, further examples include installation of stock and fund trading clients/Apps and insurance service clients/Apps on the mobile bank. For another example, the door can be opened by face recognition of customers or by finger print verification. The information system in the above technical schemes can be a cloud computing system with server and Apps (shorted as A/S system); it can also be a B/S (Browser/Server) system or a C/S (Client/Server) system.

The present invention can be employed in any general purpose or special purpose computing environments or computing systems. Examples of applicable known computing systems, computing environments and/or computing configurations for the present invention include, but not limited to, personal computer, server computer, special purpose computers including banking computers, portable or laptop equipment, handsets, multiple processor systems, systems based on micro-processors, set top box, programmable consumer electronic appliances, network personal computers, small computers, large scale computers, cloud computing systems (A/S: App/Server), B/S systems, C/S systems and distributed computing environments which contain any systems and/or equipments described above, etc.

The present invention makes use of the cutting edge technologies such as 5G, AI, robotics, robotic/automatic driving etc. to create a mobile bank as a substitute or transition for entity banks during the process of banking virtualization through the internet so as to save rental and human resources cost for banks.

### DETAILED EMBODIMENT

Further description of the present invention is made in the following section with two preferred embodiments.

Preferred Embodiment One: This preferred embodiment is to build a mobile bank by equipping a properly designed vehicle that can move around with banking equipments based on 5G or other wireless communication technology such as ABM (Automatic Banking Machine), ATM (Automatic Teller Machine), ACBM (Automatic Company Banking Machine), IMM (Investment Management Machine), UBPM (Utility Bill Payment Machine), AFEM (Automatic Foreign Exchange Machine), computers, client machines and Pads etc. The banking equipments on the vehicle can communicate with the remote banking server which runs the bank information and management system processing various banking transactions and providing banking services through 5G or other wireless communication technology. The vehicle for the mobile bank is a vehicle with a driver. There are bank staffs, especially company banking staffs, on board the vehicle on duty to provide services to customers. The mobile bank can be staffed with investment advisors or equipped with AI investment advisor clients or Apps; it can also be staffed with loan advisors or equipped with AI loan advisor clients or Apps. The mobile bank is also equipped with stock and fund trading clients or Apps and insurance service clients or Apps. Meanwhile, the correspondent remote bank server runs the banking information and management system, AI investment advisor, AI loan advisor, stock and fund trading system and insurance service system. The equipments on board can communicate with the bank server through 5G or other wireless communication technology for processing bank transactions and providing banking services to customers. The mobile bank cruises along fixed routes and stops at fixed places on fixed times for service to customers. The door of the mobile bank opens automatically when stopping to provide service to customers.

Preferred Embodiment Two: This preferred embodiment is to build a mobile bank by equipping a properly designed vehicle that can move around with banking equipments based on 5G or other wireless communication technology such as ABM (Automatic Banking Machine), ATM (Automatic Teller Machine), ACBM (Automatic Company Banking Machine), IMM (Investment Management Machine), UBPM (Utility Bill Payment Machine), AFEM (Automatic Foreign Exchange Machine), computers, client machines and Pads etc. The banking equipments on the vehicle can communicate with the remote banking server which runs the bank information and management system processing various banking transactions and providing banking services through 5G or other wireless communication technology. The vehicle for the mobile bank is an unmanned robotic vehicle or a manned automatic driving vehicle. No bank staff is assigned on duty on the vehicle; but bank service robots can be equipped on board the vehicle. The mobile bank can be equipped with AI investment advisor clients or Apps and loan advisor clients or Apps. The mobile bank can also be equipped with stock and fund trading clients or Apps and insurance service clients or Apps. Meanwhile, the correspondent remote bank server runs the banking information and management system, AI investment advisor, AI loan advisor, stock and fund trading system and insurance service system. The equipments on board can communicate with the bank server through 5G or other wireless communication technology for processing bank transactions and providing banking services to customers. The mobile bank can drive to appointed place at appointed time to provide service to customers who make the appointment. In the process of driving to the appointed place, the mobile bank can keep in contact with the customer who makes the appointment by telephone or instant messages. The door of the mobile bank opens for service to the customer with the appointment through face recognition of the customer or opens automatically when it stops for providing service.

The embodiments above are examples provided for general technicians in the field to realize the present invention. Technicians in the field can make changes or modifications to the embodiments described above in accordance with the creative thoughts of the present invention. Therefore the scope of the present invention will not be limited by the above embodiments, but will be extended to the maximum extent in accordance with the creative characteristics put forward in the claims section.

1. A mobile bank, comprising:
a properly designed vehicle is equipped with one or several banking equipments to form a mobile bank, wherein the banking equipments can communicate with the bank server that runs the bank information system to process banking transactions or provide banking services through 5G or other wireless communication technology.

2. The mobile bank of claim 1, wherein the vehicle for the mobile bank can be a normal vehicle with a driver, or can be an unmanned robotic vehicle or automatic driving vehicle, or can also be a manned automatic driving vehicle.

3. The mobile bank of claim 1, wherein the banking equipments include ABM, ATM, ACBM, IMM, UBPM, AFEM, computers, client machines and Pads etc., and also include AI investment advisor clients or Apps, AI loan advisor clients or Apps, stock and fund trading clients or Apps and insurance service clients or Apps.

4. The mobile bank of claim 1, wherein the bank server can also run one or several services among AI Investment advisor, AI loan advisor, stock and fund trading system and insurance service system, correspondently the mobile bank is equipped with one or several clients or Apps among AI investment advisor clients or Apps, AI loan advisor clients or Apps, stock and fund trading clients or Apps and insurance service clients or Apps.

5. The mobile bank of claim 1, wherein there can be several mobile banks servicing at various routes at the same time, there can also be several mobile banks going to different appointed places to provide service to different customers who make appointments.

6. The mobile bank of claim 1, wherein the mobile bank can be staffed with bank staff, or no bank staff is assigned on board the mobile bank on duty, or the mobile bank can be equipped with bank service robots.

7. The mobile bank of claim 1, wherein the doors of the mobile bank can open automatically when stopping to provide service, they can also be opened by bank cards or by face recognition of a customer.

8. A system for a mobile bank, comprising:
a bank server that runs the bank information system;
and a properly designed vehicle which is equipped with one or several banking equipments, which can communicate with the said bank server to process banking transactions or provide banking services through 5G or other wireless communication technology.

9. The system of claim 8, wherein the vehicle for the mobile bank can be a normal vehicle with a driver, or can be an unmanned robotic vehicle or automatic driving vehicle, or can also be a manned automatic driving vehicle.

10. The system of claim 8, wherein the banking equipments include ABM, ATM, ACBM, IMM, UBPM, AFEM, computers, client machines and Pads etc., and also include AI investment advisor clients or Apps, AI loan advisor clients or Apps, stock and fund trading clients or Apps and insurance service clients or Apps.

11. The system of claim 8, wherein the bank server can also run one or several services among AI Investment advisor, AI loan advisor, stock and fund trading system and insurance service system, correspondently the mobile bank is equipped with one or several clients or Apps among AI investment advisor clients or Apps, AI loan advisor clients or Apps, stock and fund trading clients or Apps and insurance service clients or Apps.

12. The system of claim 8, wherein there can be several mobile banks servicing at various routes at the same time, there can also be several mobile banks going to different appointed places to provide service to different customers who make appointments.

13. The system of claim 8, wherein the mobile bank can be staffed with bank staff, or no bank staff is assigned on board the mobile bank on duty, or the mobile bank can be equipped with bank service robots.

14. The system of claim 8, wherein the doors of the mobile bank can open automatically when stopping to provide service, they can also be opened by bank cards or by face recognition of a customer.

15. The mobile bank of claim 1, wherein the mobile bank can cruise along fixed routes and stop at fixed places to provide service, or drive to appointed places at appointed times to provide service to customers who make appointments, or drive to places where people gather for events to provide service, or provide service to customers on board the vehicle during cruising, or provide service with a combination of above service modes.

16. The system of claim 8, wherein the mobile bank can cruise along fixed routes and stop at fixed places to provide service, or drive to appointed places at appointed times to provide service to customers who make appointments, or drive to places where people gather for events to provide service, or provide service to customers on board the vehicle during cruising, or provide service with a combination of above service modes.
